(19) United States
(12) Patent Application Publication
(10) Pub. No.: US 2008/0241687 A1
(43) Pub. Date: Oct. 2, 2008

(54) NONAQUEOUS ELECTROLYTE BATTERY, BATTERY PACK AND VEHICLE

(76) Inventors: Haruchika ISHII, Saku-shi (JP); Hiroki INAGAKI, Kawasaki-shi (JP); Norio TAKAMI, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/047,857

(22) Filed: Mar. 13, 2008

(30) Foreign Application Priority Data
Mar. 29, 2007 (JP) 2007-088837

(51) Int. Cl. H01M 4/06; H01M 4/36; H01M 2/10

(52) U.S. Cl. 429/218.1; 429/246; 429/100; 180/65.1

(57) ABSTRACT

A nonaqueous electrolyte battery includes a positive electrode and a negative electrode. The negative electrode includes a negative electrode current collector, a negative electrode layer and a top part. The positive electrode includes an end portion as viewed in a length direction of the positive electrode. The top part is gradually decreased in width towards an apex of the top part on one end of the current collector as viewed in a length direction of the current collector. The apex is arranged at a position corresponding to one-half of a maximum width of the negative electrode layer. The top part has a shape symmetric with respect to the position, and is arranged between the end portion of the positive electrode and a positive electrode portion outward of the end portion of the positive electrode. The end portion is arranged at a position preceding the top part.

### CROSS-REFERENCE TO RELATED APPLICATIONS

This application is based upon and claims the benefit of priority from prior Japanese Patent Application No. 2007-088837, filed Mar. 29, 2007, the entire contents of which are incorporated herein by reference.

### BACKGROUND OF THE INVENTION

1. Field of the Invention

The present invention relates to a nonaqueous electrolyte battery, and a battery pack and a vehicle using the nonaqueous electrolyte battery.

2. Description of the Related Art

The recent rapid technological developments in electronic fields have been associated with the developments of small-sized and light-weight electronic devices. This resultantly leads to developments of portable and cordless electronic devices and it is therefore strongly desired that secondary power sources serving as the driving sources of these devices are small-sized and light-weighted and have a high power density. In order to cope with these demands, lithium secondary batteries having a high power density are being developed.

The following method is disclosed in JP-A 2005-93242 (KOKAI) to manufacture high-power lithium secondary batteries. Specifically, JP-A 2005-93242 (KOKAI) discloses a method in which a plain part carrying no active material is formed on one lateral end of a band electrode and is then joined collectively after the band electrode is coiled. JP-A 2005-93242 (KOKAI) reveals that this method makes it possible to reduce the resistance of a battery without increasing the number of tabs.

Also, a method is disclosed in JP-A 2005-123183 (KOKAI) in which a negative electrode active material that has an average charge/discharge potential at a level higher than the lithium alloying potential of aluminum and a minute particle diameter and a negative electrode conductive substrate made of aluminum lighter than conventional copper are used to improve the weight power density of a battery. It is considered that when these two methods are combined, a battery having a higher weight power density can be manufactured. When a battery having a high-power density is actually mass-produced, an electrolytic solution is usually injected from the side surface of an electrode group. The electrolytic solution penetrates to the interior of an active material-containing layer formed in current collectors of a positive electrode and a negative electrode through pores formed in the surface of the active material-containing layer by the capillary phenomenon. However, because the surface of the active material-containing layer is not exposed from the side surface of the electrode group, there is no alternative but to make the electrolytic solution penetrate to the interior of the electrode group along the current collector lacking in the ability of retaining an electrolytic solution. This leads to prolongation and redundancy of the penetration process of the electrolytic solution. Also, if moisture is included in the electrode group during the penetration process, this largely affects the performance of the battery and the prolongation of the penetration process leads to a reduction in yield.

It has been known that the penetration ability obtained when a material, for example, a lithium titanate and chalcogenide type compound having an average working potential higher than the lithium alloying potential of aluminum used as the negative electrode active material, is inferior to that obtained when a carbon material is used as the negative electrode active material. Moreover, it has been known that these negative electrode active materials having a higher specific surface area are advantageous in large-current performance. However, if the specific surface area of the negative electrode active material is increased, it is more difficult for the electrolytic solution to penetrate. This leads to a reduction in the utilization factor of the negative electrode and it is therefore difficult to obtain high power.

In the meantime, JP-A 9-169456 (KOKAI) discloses that the end part of an electrode sheet is made into an arc-form or angle-form to prevent the generation of winding wrinkles formed when the electrode sheet of a lithium ion secondary battery is coiled.

### BRIEF SUMMARY OF THE INVENTION

According to a first aspect of the present invention, there is provided a nonaqueous electrolyte battery, comprising an electrode group in which a band-shaped positive electrode and a band-shaped negative electrode are wound in the form of a flat coil with a separator interposed between the positive and negative electrodes, and a nonaqueous electrolyte supported by the electrode group,

the negative electrode including:

a negative electrode current collector made of aluminum or an aluminum alloy;

a negative electrode layer which is formed on the negative electrode current collector excluding at least both end parts as viewed in a width direction of the current collector and contains a negative electrode active material providing a negative electrode average working potential higher than a lithium alloying potential of aluminum; and

a top part gradually decreased in width towards an apex of the top part on one end of the current collector as viewed in a length direction of the current collector, and the apex of the top part arranged at a position corresponding to one-half of a maximum width of the negative electrode layer, and the top part having a shape symmetric with respect to the position;

the positive electrode including an end portion as viewed in a length direction of the positive electrode;

wherein the top part of the negative electrode is arranged between the end portion of the positive electrode and a positive electrode portion outward of the end portion of the positive electrode, and the end portion of the positive electrode is arranged at a position preceding the top part of the negative electrode.

According to a second aspect of the present invention, there is provided a battery pack comprising a nonaqueous electrolyte battery comprising an electrode group in which a band-shaped positive electrode and a band-shaped negative electrode are wound in the form of a flat coil with a separator interposed between the positive and negative electrodes, and a nonaqueous electrolyte supported by the electrode group,

the negative electrode including:

a negative electrode current collector made of aluminum or an aluminum alloy;

a negative electrode layer which is formed on the negative electrode current collector excluding at least both end parts as viewed in a width direction of the current collector and contains a negative electrode active material providing a negative electrode average working potential higher than a lithium alloying potential of aluminum; and

a top part gradually decreased in width towards an apex of the top part on one end of the current collector as viewed in a length direction of the current collector, and the apex of the top part arranged at a position corresponding to one-half of a maximum width of the negative electrode layer, and the top part having a shape symmetric with respect to the position;

the positive electrode including an end portion as viewed in a length direction of the positive electrode;

wherein the top part of the negative electrode is arranged between the end portion of the positive electrode and a positive electrode portion outward of the end portion of the positive electrode, and the end portion of the positive electrode is arranged at a position preceding the top part of the negative electrode.

### BRIEF DESCRIPTION OF THE SEVERAL VIEWS OF THE DRAWING

FIG. 1 is an exploded perspective view of a nonaqueous electrolyte battery according to a first embodiment;

FIG. 2 is typical view for explaining the structure of an electrode group to be used in the nonaqueous electrolyte battery of FIG. 1;

FIG. 3 is an enlarged top plan view of the electrode group shown in FIG. 2;

FIG. 4 is a typical view for explaining a process of producing an electrode group used in the nonaqueous electrolyte battery of FIG. 1;

FIG. 5 is a typical view for explaining the shapes of positive and negative electrodes used in the nonaqueous electrolyte battery of FIG. 1;

FIG. 6 is a typical sectional view taken along the VI-VI line of the electrode group used in the nonaqueous electrolyte battery of FIG. 1;

FIG. 7 is a plan view showing another example of the shape of the ends of the positive electrode and the negative electrode used in the nonaqueous electrolyte battery of FIG. 1;

FIG. 8 is a plan view showing a further example of the shape of the ends of the positive electrode and the negative electrode used in the nonaqueous electrolyte battery of FIG. 1;

FIG. 9 is an exploded perspective view of a battery pack according to a second embodiment;

FIG. 10 is a block diagram showing an electric circuit of the battery pack of FIG. 9;

FIG. 11 is a typical view showing a series hybrid vehicle according to a third embodiment;

FIG. 12 is a typical view showing a parallel hybrid vehicle according to the third embodiment;

FIG. 13 is a typical view showing a series-parallel hybrid vehicle according to the third embodiment;

FIG. 14 is a typical view showing a vehicle according to the third embodiment;

FIG. 15 is a typical view showing a hybrid motor bicycle according to the third embodiment;

FIG. 16 is a typical view showing an electric motor bicycle according to the third embodiment;

FIG. 17 is a typical view showing a rechargeable vacuum cleaner according to a fourth embodiment;

FIG. 18 is a structural view of the rechargeable vacuum cleaner of FIG. 17; and

FIG. 19 is a plan view showing the shape of the ends of a positive electrode and a negative electrode used in a nonaqueous electrolyte battery of Comparative Example 3.

### DETAILED DESCRIPTION OF THE INVENTION

### First Embodiment

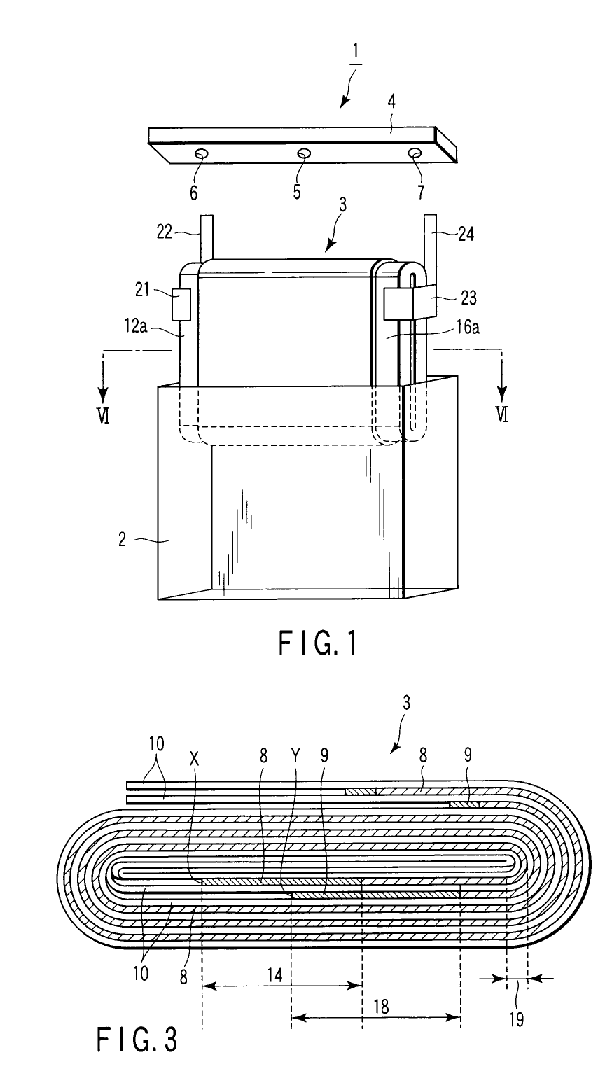

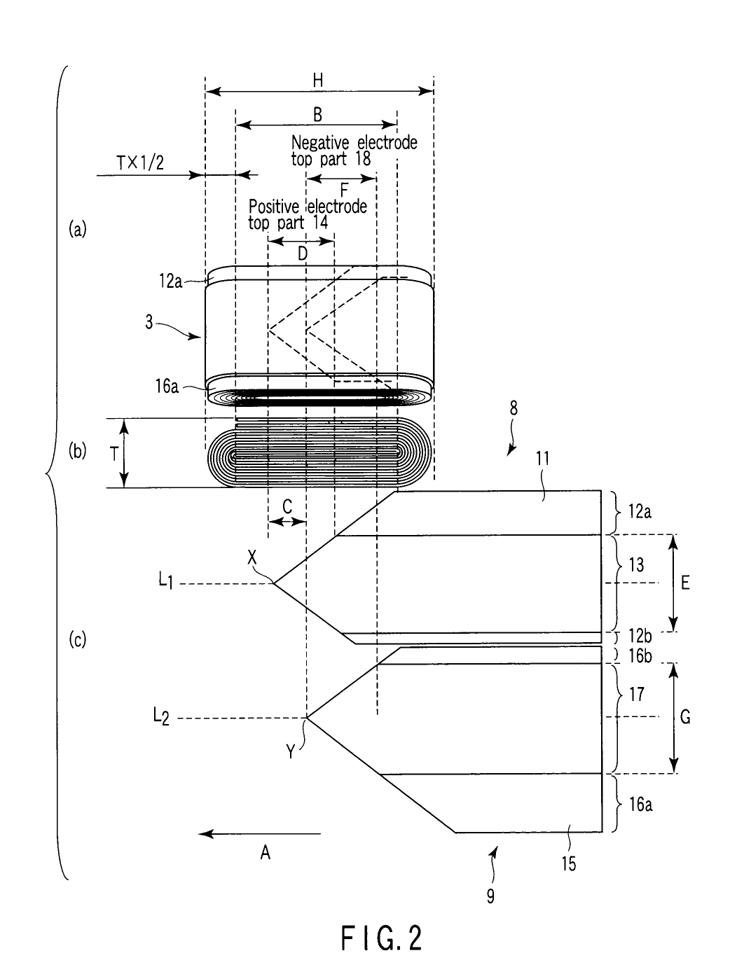

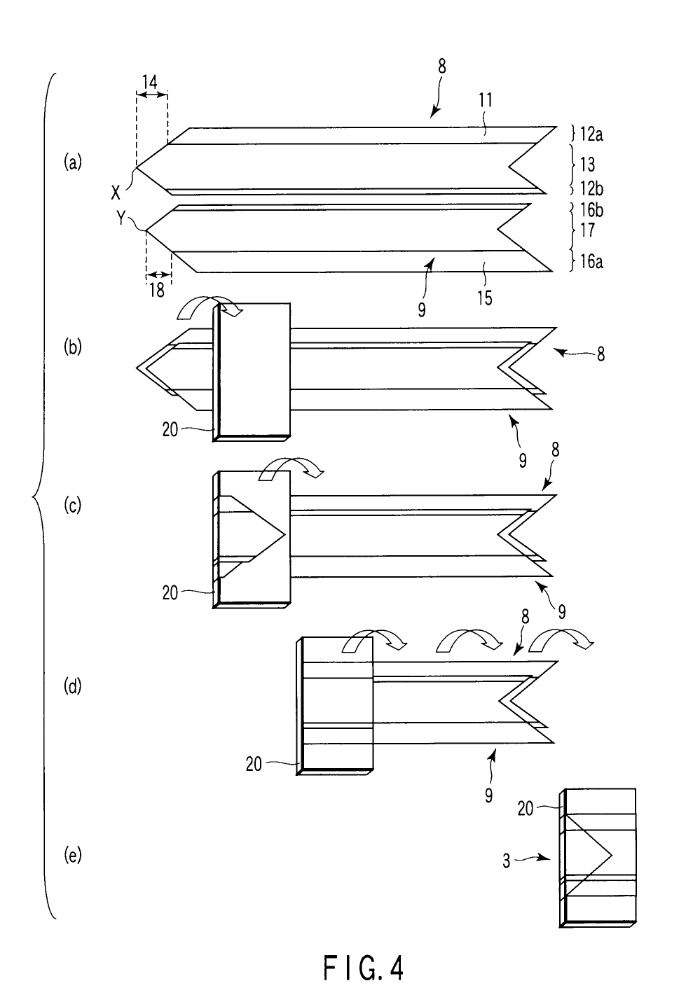

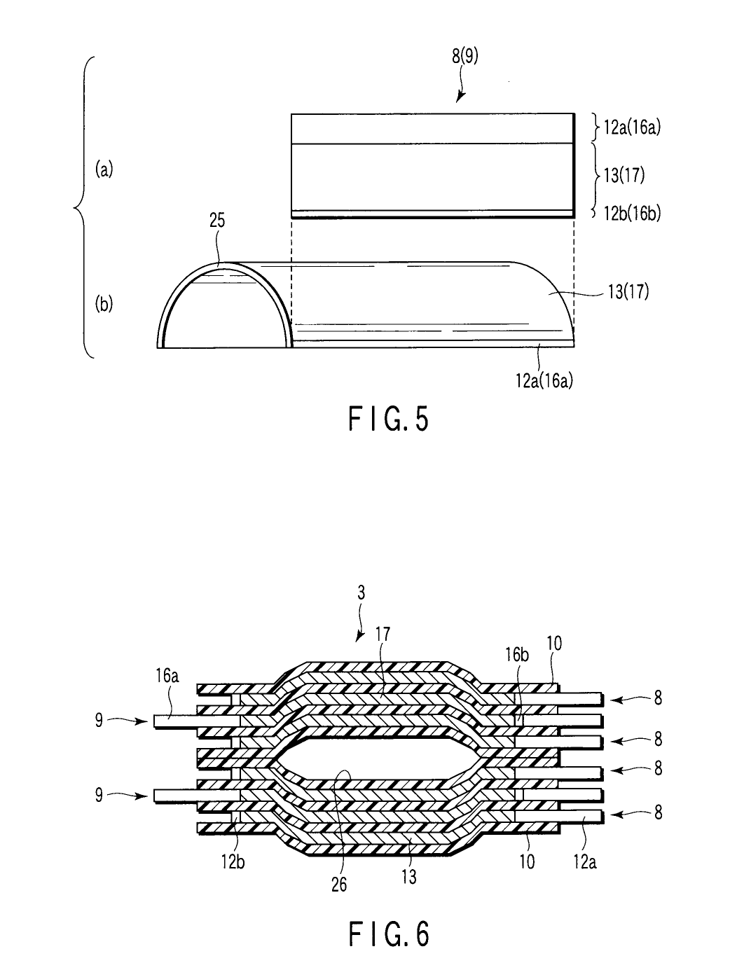

A nonaqueous electrolyte battery according to a first embodiment will be explained with reference to FIGS. 1 to 5. FIG. 1 is an exploded perspective view of the nonaqueous electrolyte battery according to the first embodiment. FIG. 2(a) is a typical plan view of an electrode group used in the nonaqueous electrolyte battery, FIG. 2(b) is a typical top plan view of the electrode group and FIG. 2(c) is a typical view showing the positional relationship between the ends of positive and negative electrodes in the electrode group. FIG. 3 is an enlarged top plan view of the electrode group shown in FIG. 2(b). FIG. 4 is a typical view for explaining a process of producing the electrode group used in the nonaqueous electrolyte battery of FIG. 1. FIG. 5(a) is a plan view of the center part of the positive and negative electrodes used in the nonaqueous electrolyte battery of FIG. 1 and FIG. 5(b) is a perspective view of the center part of the positive and negative electrodes of FIG. 5(a). FIG. 6 is a typical sectional view taken along the VI-VI line of the electrode group used in the nonaqueous electrolyte battery of FIG. 1.

As shown in FIG. 1, a nonaqueous electrolyte battery 1 comprises a container 2, an electrode group 3 received in the container 2 and a seal plate 4 for sealing an opening of the container 2. The container 2 has a rectangular cylinder form with a bottom and is made of, for example, a metal. Examples of metals constituting the container are aluminum, aluminum alloy, iron and stainless steel. The plate thickness of the container is designed to be preferably 0.5 mm or less and more preferably 0.2 mm or less.

The seal plate 4 is a rectangular metal plate and is fitted to the opening of the container 2 by, for example, laser welding. Examples of metal materials used to form the seal plate 4 are the same materials that have been explained as regards the container 2. A liquid injection port 5 is made in the vicinity of the center of the seal plate 4. A positive electrode terminal hole 6 from which a positive electrode terminal is drawn is formed in the vicinity of one end (on the left in FIG. 1) of the seal plate 4. A negative electrode terminal hole 7 from which a negative electrode terminal is drawn is formed in the vicinity of the other end (on the right in FIG. 1) of the seal plate 4.

The electrode group 3, as shown in FIG. 3, has a structure in which a band positive electrode 8 and a band negative electrode 9 are wound in the form of a coil having a flat form through a separator 10 interposed therebetween. As shown in FIG. 2(c), the positive electrode 8 comprises a positive electrode current collector 11 and a positive electrode active material-containing layer 13 formed on at least one surface (on both surfaces in this case) of the positive electrode current collector 11 excluding both end parts 12a, 12b as viewed in the width direction of the positive electrode current collector 11. In this case, the both end parts 12a, 12b are arranged on the long sides of the positive electrode current collector 11. The width of the end part 12a is larger than the width of the end part 12b. In this case, the width of each of the end parts 12a, 12b corresponds to the length in the short side direction of each of the end parts 12a, 12b. The positive electrode 8 has a top part 14 having an isosceles triangle form decreased in width toward the apex X on one longitudinal end thereof, that is, a top part 14 made into an isosceles triangle form obtained by decreasing the width of the positive electrode active material-containing layer 13 in the direction A toward one short side. The apex X of the top part 14 of the positive electrode 8 exists at the position (shown by the dotted line L₁) corresponding to one-half of the maximum width E of the positive electrode active material-containing layer 13. Also, the shape of the top part 14 of the positive electrode 8 is symmetric with respect to the dotted line L₁. If the top part 14 has an asymmetric shape, and, for example, if the lengths of two sides of the triangle are different from each other, the shorter side has a narrower entrance for introducing the electrolytic solution and therefore, the penetration of the electrolytic solution into the shorter side is slower. Each width of both end parts 12a, 12b decreases linearly along the direction A from the position just behind the top part 14.

On the other hand, the negative electrode 9 comprises a negative electrode current collector 15 made of an aluminum or an aluminum alloy and a negative electrode layer 17 which is formed on at least one surface (on both surfaces in this case) of the negative electrode current collector 15 excluding both end parts 16a, 16b as viewed in the width direction of the negative electrode current collector 15 and contains a negative electrode active material having a negative electrode average working potential higher than the lithium alloying potential of aluminum. In this case, the both end parts 16a, 16b as viewed in the width direction of the negative electrode current collector 15 are arranged on the long sides of the negative electrode current collector 15. The use of the above negative electrode current collector 15 and the negative electrode active material bring about a high weight power density. The width of the end part 16a is larger than the width of the end part 16b. In this case, the width of each of the end parts 16a, 16b corresponds to the length in the short side of each of the end parts 16a, 16b. The negative electrode 9 has a top part 18 having an isosceles triangle form decreased in width toward the apex Y on one longitudinal end thereof, that is, a top part 18 made into an isosceles triangle form obtained by decreasing the width of the negative electrode layer 17 in the direction A toward one short side. The apex Y of the top part 18 of the negative electrode 9 exists at the position (shown by the dotted line L₂) corresponding to one-half of the maximum width G of the negative electrode layer 17. Also, the shape of the top part 18 of the negative electrode 9 is symmetric with respect to the dotted line L₂. If the top part 18 has an asymmetric shape, and, for example, if the lengths of two sides of the triangle are different from each other, the shorter side has a narrower entrance for introducing the electrolytic solution and therefore, the penetration of the electrolytic solution into the shorter side is difficult. Each width of both ends 16a, 16b decreases linearly along the direction A from the position just behind the top part 18.

As shown in FIG. 3, the separators 10 overlapped double on each other are wound several times in the innermost periphery of the electrode group 3. The apex X of the top part 14 of the positive electrode 8 is wound before the apex Y of the top part 18 of the negative electrode 9 is wound. Therefore, the apex X of the top part 14 of the positive electrode 8 is arranged at a position preceding the apex Y of the top part 18 of the negative electrode 9, and the apex X of the top part 14 of the positive electrode 8 is called a coiling start part. Also, the apex Y of the top part 18 of the negative electrode 9 is disposed between the top part 14 of the positive electrode 8 and the next positive electrode portion which is wound one round after the above positive electrode 8 is wound and is arranged outward of the top part 14 of the positive electrode 8. Moreover, the top part 18 of the negative electrode 9 preferably exists at a position preceding a first bent part 19 of the positive electrode 8.

An example of a method of winding the electrode group 3 will be explained with reference to FIG. 4. In FIG. 4, the separator is omitted to clarify the positional relation between the positive electrode and the negative electrode. First, as shown in FIG. 4(a), the positive electrode 8 and the negative electrode 9 are arranged such that the apex X of the top part 14 of the positive electrode 8 precedes the apex Y of the top part 18 of the negative electrode 9. Then, as shown in FIG. 4(b), the end part 12a of the positive electrode 8 is disposed at a position shifted to the outer side (upper side in FIG. 4) than the position of the negative electrode 9 and the separator, and the end part 16a of the negative electrode 9 is disposed at a position shifted further towards the outer side (lower side in FIG. 4) than the position of the positive electrode 8 and the separator. This plate electrode is wound in a flat form by using a core 20 having a flat form, as shown in FIGS. 4(c), 4(d) and 4(e).

After the core 20 is pulled out of the obtained electrode group 3, the electrode group 3 may be subjected to a heat press. Also, the positive electrode 8, the negative electrode 9 and the separator 10 may be integrated by using an adhesive polymer.

As shown in FIG. 1, the end part 12a of the positive electrode 8 is projected more externally than the negative electrode 9 and the separator 10 from one end surface (on the left in FIG. 1) of the electrode group 3. A positive electrode lead 21 is welded to the end part 12a on one end surface of the electrode group 3. One end of a positive electrode tab 22 as a positive electrode terminal is welded to the positive electrode lead 21 and the other end is drawn externally through the positive electrode terminal hole 6 of the seal plate 4. As shown in FIG. 1, the end part 16a of the negative electrode 9 is projected more externally than the positive electrode 8 and the separator 10 from the other end surface (on the right in FIG. 1) of the electrode group 3. A negative electrode lead 23 is welded to the end part 16a on the end surface of the other side of the electrode group 3. One end of a negative electrode tab 24 as a negative electrode terminal is welded to the negative electrode lead 23 and the other end is drawn externally through the negative electrode terminal hole 7 of the seal plate 4. The positive electrode terminal hole 6 through which the positive electrode tab 22 passes is hermetically sealed with a resin to keep the battery airtight. The positive electrode tab 22 is electrically insulated from the seal body 4 by this resin hermetic structure. The negative electrode tab 24 is also insulated from the negative electrode terminal hole 7 by this hermetic structure, and the negative electrode terminal hole 7 is hermetically sealed by this hermetic structure.

The positive electrode lead 21 and the positive electrode tab 22 may be formed using a material having electric stability and conductivity in a potential range of 3V to 5V with respect to a lithium ion metal. Specific examples of the material include aluminum and an aluminum alloy containing Mg, Ti, Zn, Mn, Fe, Cu or Si. It is preferable to use the same material that is used for the positive electrode current collector to the reduce contact resistance. The negative electrode lead 23 and the negative electrode tab 24 may be formed using a material having electric stability and conductivity in a potential range of 0.4V to 3V with respect to a lithium ion metal. Specific examples of the material include aluminum and an aluminum alloy containing Mg, Ti, Zn, Mn, Fe, Cu or Si. It is preferable to use the same material that is used for the negative electrode current collector to reduce the contact resistance.

A liquid nonaqueous electrolyte (not shown) such as a nonaqueous electrolytic solution is supported by the electrode group 3.

In the nonaqueous electrolyte battery having the structure mentioned above, the nonaqueous electrolytic solution is supplied to the electrode group 3 through the injection port 5 as shown in FIG. 1 as mentioned above. For this reason, as to a path through which the nonaqueous electrolytic solution is diffused in the electrode group 3, a path through which the electrolytic solution penetrates most rapidly is as follows: the electrolytic solution diffuses to the end surface of the electrode group 3 along the outermost peripheral surface of the electrode group 3 and penetrates to the interior of the electrode group 3 from the end surface of the electrode group 3, that is, from both sides of the electrode group 3 in the direction of the coil axis. However, the positive electrode current collector and negative electrode current collector into which the electrolytic solution scarcely penetrates are projected from this end surface. Also, in order to improve the weight power density of the battery, the battery preferably has each of the structures (I) to (IV).

(I) As the negative electrode active material, a material is used that is more increased in negative electrode average working potential than the lithium alloying potential of aluminum.

(II) The specific surface area of this negative electrode active material is 1 to 10 m²/g.

(III) A negative electrode current collector made of aluminum or an aluminum alloy is used.

(IV) The thickness of the active material-containing layer of the negative electrode is designed to be larger than that of the active material-containing layer of the positive electrode.

However, the negative electrode having the structure of the above (I) to (IV) is inferior in impregnation with the electrolytic solution.

When the negative electrode 9 having the above top part 18 is arranged in the vicinity of the center of the electrode group 3 as mentioned above, a space is formed in the vicinity of the center of the electrode group 3 and therefore, the penetration of the electrolytic solution into the vicinity of the center of the electrode group 3 can be promoted. Also, since this top part 18 has an apex Y at the position L₂ corresponding to one-half of the maximum width G of the negative electrode layer 17, and also, has a shape symmetric with respect to the position L₂, the electrolytic solution is diffused rapidly and uniformly. From the above result, the negative electrode can be sufficiently impregnated with the electrolytic solution, the resistance can be reduced and therefore, a nonaqueous electrolyte battery having a high power density can be attained.

Also, as the positive electrode 8 has the top part 14, a high volume capacity density can be obtained. Further, since a sufficient space is formed in the vicinity of the center of the electrode group 3, it is expected to obtain the effect of further promoting the penetration of the electrolytic solution into the vicinity of the center of the electrode group 3. Furthermore, since this top part 14 has an apex X at the position L₁ corresponding to one-half of the maximum width E of the positive electrode active material-containing layer 13, and also, has a shape symmetric with respect to the position L₁, the electrolytic solution is diffused rapidly and uniformly. Therefore, the positive electrode 8 and the negative electrode 9 can be sufficiently impregnated with the electrolytic solution, which further improve the output ability of the nonaqueous electrolyte battery.

Since, as mentioned above, the top part 18 of the negative electrode 9 is disposed between the top part 14 of the positive electrode 8 and the next positive electrode portion outward of the top part 14 of the positive electrode 8, and the apex X of the top part 14 of the positive electrode 8, which is called the start point of coiling, is wound before the apex Y is wound, high power is obtained. In order to improve the output performance, it is desirable to arrange the top part 14 of the positive electrode 8 in the part B extending from the end of the electrode group 3 at a height H, that is, the end parallel to the coil axis, to a position at a distance of one-half or more of the thickness T of the electrode group 3. Here, the height H of the electrode group 3 means the length in a direction perpendicular to the coil axis, which is the direction in which the positive electrode current collector 12a and the negative electrode current collector 16a are projected. The thickness T of the electrode group 3 means the length of the short side of the end surface of the electrode group 3.

When at least a part of the top part 14 of the positive electrode 8 is disposed at the end of the electrode group 3 at a height H or in a part at a distance less than one-half of the thickness T of the electrode group 3 from this end, the top part 14 of the positive electrode 8 and the top part 18 of the negative electrode 9 are positioned in a part having a large curvature in the electrode group 3. As a result, a high tensile stress is applied to the separator 10 sandwiched between the top part 14 of the positive electrode 8 and the top part 18 of the negative electrode 9 and therefore, the separator 10 is twisted, with the result that the separator 10 is unevenly impregnated with the electrolytic solution. There is therefore a fear that a high output performance will not be obtained.

When the top part 14 of the positive electrode 8 is disposed in the part B extending from the end of the electrode group 3 at a height H to a position at a distance of one-half or more of the thickness T of the electrode group 3, the separator 10 is prevented from being twisted and it is therefore possible to obtain a high output performance. At this time, the distance C between the apex X of the top part 14 of the positive electrode 8 and the apex Y of the top part 18 of the negative electrode 9 is preferably designed to be 0.5 mm (0.05 cm) or more and 50 mm (5 cm) or less. When the distance C is 0.5 mm or more, a sufficient space can be formed in the vicinity of the center of the electrode group 3. Also, when the distance C is 50 mm or less, a high energy density can be obtained.

The positive electrode 8 and the negative electrode 9 may be respectively curved such that a section 25 obtained when they are cut along the width directions of the positive and negative electrodes 8 and 9 respectively has a curved form, as shown in FIG. 5. In this case, a plane projected due to the bending is preferably positioned on the outer peripheral side of the electrode group 3, as shown in FIG. 6. Such a structure provides a space 26 extending in a direction toward the inside from both side surfaces of the electrode group 3, whereby the diffusion of the electrolytic solution which penetrates from the end surface of the electrode group 3 into the inside can be further promoted.

When the positive electrode 8 and the negative electrode 9 each have a curvature form, the ratio (D/E) of the length D of the top part 14 of the positive electrode 8 to the maximum width E in the short side direction of the positive electrode active material-containing layer 13 is preferably 1.001 or more and more preferably 1.001 to 1.004, when the maximum width E in the short side direction of the positive electrode active material-containing layer 13 is 1. Also, the ratio (F/G) of the length F of the top part 18 of the negative electrode 9 to the maximum width G in the short side direction of the negative electrode layer 17 to is preferably 1.001 or more and more preferably 1.001 to 1.004, when the maximum width G in the short side direction of the negative electrode layer 17 is 1. If D/E or F/G is less than 1.001, the entrance for the penetration of the electrolytic solution in the axis direction is narrower, and therefore, the penetration of the electrolytic solution into the electrode group is slower. Also, if D/E or F/G exceeds 1.004, excessively large voids are formed, and therefore it takes time to penetrate the electrolytic solution by decompression with the intention of defoaming.

The widths of each of end parts 12a and 12b of the positive electrode 8 and widths of each of end parts 16a and 16b of the negative electrode 9 are desirably designed to be 1 mm to 40 mm. When the width is less than 1 mm, the curvature of the electrode cannot be retained and therefore, a necessary path for penetrating the electrolytic solution cannot be retained inside the electrode group. When the width exceeds 40 mm, on the other hand, the volume of a part which does not contribute to charge and discharge is too large and there is therefore a fear that the volume output density of the battery is reduced.

As to the thickness of the positive electrode current collector 11 of the positive electrode 8, the thickness of the part where the positive electrode active material-containing layer 13 is formed is preferably 1.001 to 1.004 times that of each of both end parts 12a and 12b. As to the thickness of the negative electrode current collector 15 of the negative electrode 9, the thickness of the part where the negative electrode layer 17 is formed is preferably 1.001 to 1.004 times that of each of both end parts 16a and 16b. When the thickness ratio is less than 1.001, the curvature of the electrode is cannot provide a sufficient path for the penetration of the electrolytic solution in the electrode group. When the thickness ratio is larger than 1.004, on the other hand, the electrode group is swelled and therefore, the battery is increased in size, leading to a lower volume output density.

The negative electrode, the positive electrode, the separator and the nonaqueous electrolyte will be explained.

1) Negative Electrode

As the negative electrode current collector, aluminum or an aluminum alloy may be used. If, for example, copper is used, the battery is increased in weight because of a difference in specific gravity, which is undesirable. Also, because the distortion of the current collector after pressed does not fit to the aluminum current collector of the positive electrode, unnecessary voids are generated between layers of the positive and negative electrodes, which inhibits the impregnation with the electrolytic solution and therefore, the use of aluminum or an aluminum alloy is desirable.

As the aluminum alloy used for the negative electrode current collector, alloys containing elements such as magnesium, zinc and silicon are preferable. The purity of an aluminum foil used for the negative electrode current collector is preferably 99% or more. The content of transition metals such as iron, copper, nickel and chromium in the negative electrode current collector is preferably reduced to 1% or less.

The thickness of the negative electrode current collector is preferably 20 μm or less and more preferably 15 μm or less.

A negative electrode active material having a negative electrode average working potential higher than the lithium alloying potential of aluminum can suppress the precipitation of lithium caused by the precedence of the short side, which is the start of coiling of the positive electrode; that is, the precedence of the apex of the top part over the apex of the top part of the negative electrode. As this negative electrode active material, for example, iron sulfide, iron oxide, titanium oxide, nickel oxide, cobalt oxide, tungsten oxide, molybdenum oxide, titanium sulfide or lithium titanate may be used. Particularly, lithium titanate is superior in cycle performance and among these compounds, lithium titanate represented by the chemical formula: Li₄₊ₓTi₅O₁₂ (x is variable in the following range: 0≦x≦3, depending on a charge/discharge reaction) and having a spinel type structure is preferable. Here, the average working potential of the negative electrode means a value obtained by dividing the charge/discharge electric power by the charge/discharge amount of electricity. This charge/discharge electric power is consumed in the case of charging/discharging at the upper limit and lower limit of the charge/discharge potential of the negative electrode when a charge/discharge operation of the battery is performed in the range of the recommended working voltage of the battery.

The specific surface area of the negative electrode active material measured by the BET method using N₂ adsorption is preferably 1 to 10 m²/g. When the specific surface area is less than 1 m²/g, the effective area contributing to an electrode reaction is small and there is therefore a fear that the large-current discharge performance is deteriorated. When the specific surface area exceeds 10 m²/g, on the other hand, the amount of reaction between the negative electrode and the nonaqueous electrolyte is increased, and there is therefore a fear of a reduction in charge/discharge efficiency and a fear of inducing the generation of gas during storage.

The negative electrode layer may contain a conductive agent and a binder if necessary.

As the above conductive agent, a carbonaceous material is used. In the case where the active material itself has a high conductivity, the conductive agent may be unnecessary.

Examples of the binder include polytetrafluoroethylene (PTFE), polyvinylidene fluoride (PVdF) and fluorine type rubber.

The compounding ratio of the negative electrode active material, conductive agent and binder is preferably designed to be as follows: the negative electrode active material: 70 to 96% by weight, the conductive agent: 2 to 28% by weight, and the binder: 2 to 28% by weight. When the amount of the conductive agent is less than 2% by weight, this brings about an inferior current collecting ability, leading to a deterioration in large-current performance. However, when the negative electrode active material has a very high conductivity, the conductive agent may be unnecessary. In this case, the compounding ratio of the binder is preferably 2 to 29% by weight. When the amount of the binder is less than 2% by weight, the ability to bind the composite layer with the current collector is inferior, leading to deteriorated cycle performance. On the other hand, the amounts of the conductive agent and binder are respectively preferably 28% by weight or less from the viewpoint of attaining high capacity.

The negative electrode is manufactured by suspending the negative electrode active material, the conductive agent and the binder in a proper solvent and by applying this suspension to a current collector such as an aluminum foil, followed by drying and pressing into a band electrode.

2) Positive Electrode

The positive electrode current collector is formed from aluminum or an aluminum alloy. As the aluminum alloy, alloys containing elements such as magnesium, zinc and silicon are preferable. The purity of an aluminum foil is preferably 99% or more. On the other hand, the content of transition metals such as iron, copper, nickel and chromium in the positive electrode current collector is 1% or less.

The thickness of the positive electrode current collector is preferably 20 μm or less and more preferably 15 μm or less.

Examples of the positive electrode active material used in the positive electrode active material-containing layer include various oxides and sulfides. Specific examples of the positive electrode active material include manganese dioxide (MnO₂), iron oxide, copper oxide, nickel oxide, lithium-manganese composite oxide (for example, LiₓMn₂O₄ and LiₓMnO₂), lithium-nickel composite oxide (for example, LiₓNiO₂), lithium-cobalt composite oxide (for example, LiₓCoO₂), lithium-nickel-cobalt composite oxide (for example, LiNi_{1-y}Co_{y}O₂), lithium-manganese-cobalt composite oxide (for example, LiMn_{y}Co_{1-y}O₂), spinel type lithium-manganese-nickel composite oxide (LiₓMn_{2-y}Ni_{y}O₄), lithium phosphate having an olivine structure (for example, LiₓFePO₄, LiₓFe_{1-y}Mn_{y}PO₄ and LiₓCoPO₄), iron sulfate (Fe₂(SO₄)₃) and vanadium oxide (for example, V₂O₅). x and y are respectively preferably in the range of 0 to 1. Specific examples of the positive electrode active material also include organic materials and inorganic materials, for example, conductive polymer materials such as polyaniline and polypyrrole, disulfide type polymer materials, sulfur (S) and fluorinated carbon. More preferable examples of the positive electrode active material for a secondary battery include lithium-manganese composite oxide, lithium-nickel composite oxide, lithium-cobalt composite oxide, lithium-nickel-cobalt composite oxide, spinel type lithium-manganese-nickel composite oxide, lithium-manganese-cobalt composite oxide and lithium iron phosphate. This is because these active materials enable a high battery voltage.

The positive electrode active material-containing layer may contain a conductive agent and a binder.

Examples of the conductive agent include acetylene black, carbon black and graphite. Also, in the case where the active material itself has a high conductivity, the conductive agent may be unnecessary.

Examples of the binder include polytetrafluoroethylene (PTFE), polyvinylidene fluoride (PVdF) and fluorine type rubber.

The compounding ratio of the positive electrode active material, conductive agent and binder is preferably designed to be as follows: the positive electrode active material: 80 to 95% by weight, the conductive agent: 3 to 18% by weight, and the binder: 2 to 17% by weight.

3) Separator

As the separator, a porous separator is used. Examples of the material used for the porous separator include porous films containing polyethylene, polypropylene, cellulose or polyvinylidene fluoride (PVdF) and synthetic resin nonwoven fabrics. Among these materials, porous films made of polyethylene, polypropylene or both are preferable because the safety of a secondary battery can be improved.

4) Nonaqueous Electrolyte

As the nonaqueous electrolyte, a nonaqueous electrolytic solution prepared by dissolving an electrolyte in an organic solvent may be used. Also, as the nonaqueous electrolyte, an ionic liquid containing lithium ions may also be used.

Examples of the electrolyte include lithium salts such as lithium perchlorate (LiClO₄), lithium hexafluorophosphate (LiPF₆), lithium tetrafluoroborate (LiBF₄), lithium hexafluoroarsenate (LiAsF₆), lithium trifluoromethanesulfonate (LiCF₃SO₃) and bistrifluoromethylsulfonylimide lithium [LiN(CF₃SO₂)₂]. The electrolyte is preferably dissolved in an amount of 0.5 to 3 mol/L in an organic solvent. The amount of the electrolyte is more preferably 1.5 to 3 mol/L.

If the concentration of the electrolyte is high, this is advantageous in ion diffusion rate; however, the viscosity of the nonaqueous electrolyte is increased, posing a problem concerning impregnation with the electrolytic solution. However, when the present invention is used, an improvement in impregnation ability is expected and therefore, the electrolyte can be used in a concentration as high as 1.5 to 3 mol/L. When the nonaqueous electrolyte has a viscosity of 5 cp or more at 20° C., the impregnation ability can be improved more significantly. The upper limit of the viscosity at 20° C. may be designed to be 30 cp.

Examples of the above organic solvent may include cyclic carbonates such as ethylene carbonate (EC), propylene carbonate (PC) and vinylene carbonate (VC); chain carbonates such as dimethyl carbonate (DMC), methylethyl carbonate (MEC) and diethyl carbonate (DEC); cyclic ethers such as tetrahydrofuran (THF) and 2-methyltetrahydrofuran (2MeTHF); chain ethers such as dimethoxyethane (DME); γ-butyrolactone (BL), acetonitrile (AN) and sulfolane (SL). These organic solvents may be used either singly or in a combination of two or more.

The electrolytic solution preferably contains at least γ-butyrolactone. This is because the vapor pressure of the electrolytic solution is very low, which therefore provides high safety. Also, this electrolytic solution has the problem that when this electrolytic solution is used as a major component, it is highly viscous and therefore entails difficulty in the impregnation therewith. However, when the method of the present invention is used, this improves the impregnation ability and is therefore very desirable.

The ionic liquid means a salt, at least a part of which exhibits a liquid state at room temperature, wherein the room temperature means a temperature range in which a power source is normally operated. The description “a temperature range in which a power source is normally operated” means a temperature range of which the upper limit is about 120° C. and depending on the case, about 60° C. and the lower limit is about −40° C. and depending on the case, about −20° C.

The ionic liquid contains a combination of a lithium salt and an organic cation.

Because a nonaqueous electrolyte containing an ionic liquid has a high viscosity, it has posed a problem concerning penetration into a negative electrode. However, the use of the present invention ensures an improvement in impregnation ability, making it possible to attain a high power output.

As the lithium salt, lithium salts having a wide potential window and used for lithium secondary batteries are used. Specific examples of the lithium salt include, but are not limited to, LiBF₄, LiPF₆, LiClO₄, LiCF₃SO₃, LiN(CF₃SO₂)₂, LiN(C₂FsSO₂) and LiN(CF₃SC(C₂F₅SO₂)₃. These compounds may be used either singly or in combination of two or more.

The content of the lithium salt is preferably 0.1 to 3 mol/L and more preferably 1 to 2 mol/L. When the content of the lithium salt is less than 0.1 mol/L, the nonaqueous electrolyte has a large resistance and there is therefore a fear that the large-current and low-temperature discharge characteristics are deteriorated. Also, when the content of the lithium salt exceeds 3.0 mol/L, the melting point of the nonaqueous electrolyte is raised and it is therefore difficult to keep the nonaqueous electrolyte in a liquid state.

The ionic liquid refers to those containing a quaternary ammonium organic cation having a skeleton represented by the formula (1) or those containing an imidazolium cation having a skeleton represented by the formula (2).

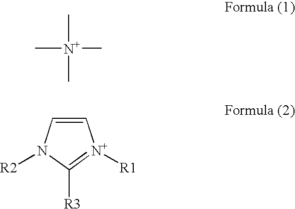

In the formula (2), R1 and R2 respectively represent CₙH₂ₙ₊₁ (n=1 to 6) and R3 represents H or CₙH₂ₙ₊₁ (n=1 to 6).

These ionic liquids having these cations may be used either singly or in combination of two or more.

Examples of the quaternary ammonium organic cation having a skeleton represented by the formula (1) include, though not limited to, imidazolium ions such as ions of dialkylimidazolium or trialkylimidazolium, tetraalkylammonium ions, alkylpyridinium ioms, pyrazolium ions, pyrrolidinium ions and piperidinium ions. Particularly, imidazolium cations having a skeleton represented by the formula (2) are preferable.

Examples of the tetraalkylammonium ion include, though not limited to, trimethylethylammonium ions, trimethylethylammonium ions, trimethylpropylammonium ions, trimethylhexylammonium ions and tetrapentylammonium ions.

Also, examples of the alkylpyridinium ions include, though not limited to, N-methylpyridinium ions, N-ethylpyridinium ions, N-propylpyridinium ions, N-butylpyridinium ions, 1-ethyl-2-methylpyridinium ions, 1-butyl-4-methylpyridinium ions and 1-butyl-2,4-dimethylpyridinium ions.

Examples of the imidazolium cation represented by the formula (2) include, though not limited to, dialkylimidazolium ions and trialkylimidazolium ions.

Examples of the dialkylimidazolium ions include, though not limited to, 1,3-dimethylimidazolium ions, 1-ethyl-3-methylimidazolium ions, 1-methyl-3-ethylimidazolium ions, 1-methyl-3-butylimidazolium ions and 1-butyl-3-methylimidazolium ions.

Examples of the trialkylimidazolium ions include, though not limited to, 1,2,3-trimethylimidazolium ions, 1,2-dimethyl-3-ethylimidazolium ions, 1,2-dimethyl-3-propylimidazolium ions and 1-butyl-2,3-dimethylimidazolium ions.

The aforementioned FIGS. 1 to 6 are used to explain an example using a metal container. However, a laminate film container may be used as an outer package. As the laminate film, a multilayer film obtained by coating a metal foil such as aluminum with a resin film may be used. As the resin, a polymer such as polypropylene (PP), polyethylene (PE), nylon or polyethylene terephthalate (PET) may be used. The thickness of the laminate film may be reduced to 0.2 mm or less.

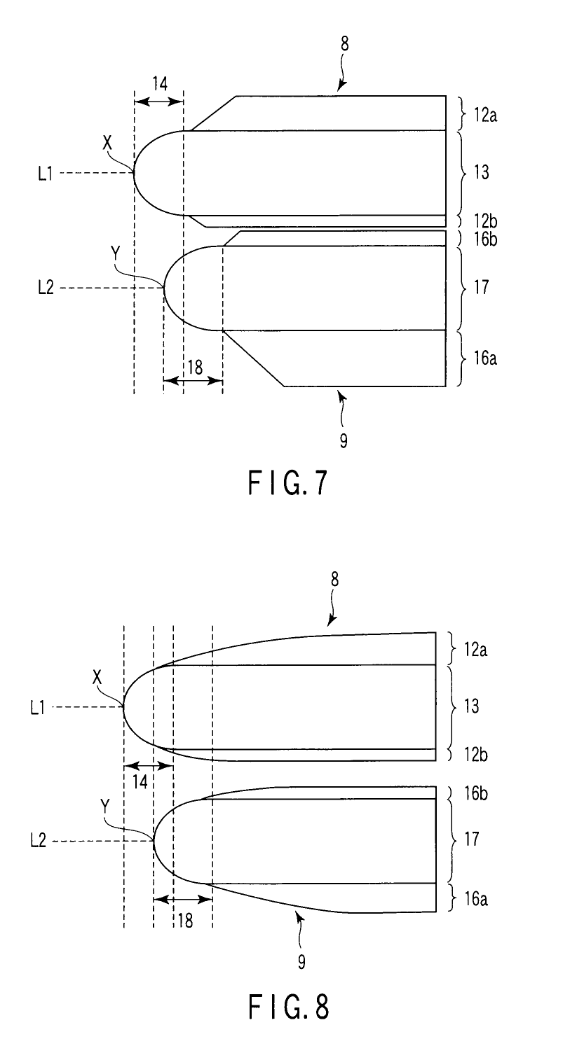

In the example shown in the above FIGS. 1 to 6, the shapes of the top parts 14 and 18 of the positive and negative electrodes 8 and 9 respectively have an isosceles triangle form. However, any form may be used as the shapes of the top parts 14 and 18 as long as it is so designed that the apexes of the top parts 14 and 18 are at positions corresponding to one-half of the maximum widths E and G in the directions of the short sides of the active material-containing layers 13 and 17 respectively, and are line-symmetric with respect to the corresponding position. As illustrated in FIG. 7, the top parts 14 and 18 may be each designed to have a semicircle shape. Alternatively, as shown in FIG. 8, all the peripheral parts, including the current collectors, may be respectively processed into a curved form while the top parts 14 and 18 respectively have a semicircle form.

An example of application of the nonaqueous electrolyte battery according to the first embodiment to charge/discharge systems is the power source of a control system driving a drive motor of an electric car.

### Second Embodiment

A battery pack according to a second embodiment comprises the nonaqueous electrolyte battery according to the first embodiment. The number of the nonaqueous electrolyte batteries may be two or more. It is preferable that the nonaqueous electrolyte battery according to the first embodiment be used as a unit cell and unit cells be arranged electrically in series or in parallel to constitute a battery module.

The nonaqueous electrolyte battery according to the first embodiment is suitable for use as a battery module and the battery pack according to the second embodiment is superior in output performance and cycle performance. The reason for this will be explained.

When the negative electrode is improved in impregnation ability with the nonaqueous electrolyte, it becomes resistant to overvoltage. As a result, the utilization factor of the negative electrode active material can be equalized because the negative electrode can be prevented from being locally overcharged or overdischarged. This makes it possible to remarkably reduce differences in capacity and in impedance between unit cells constituting the battery module. This brings about, for example, the following specific effects: because a difference in capacity between unit cells is reduced in a battery module obtained by connecting the unit cells in series, any disparity in voltage between these unit cells in a full charge state is reduced. For this reason, the battery pack according to the second embodiment is superior in output performance and cycle performance.

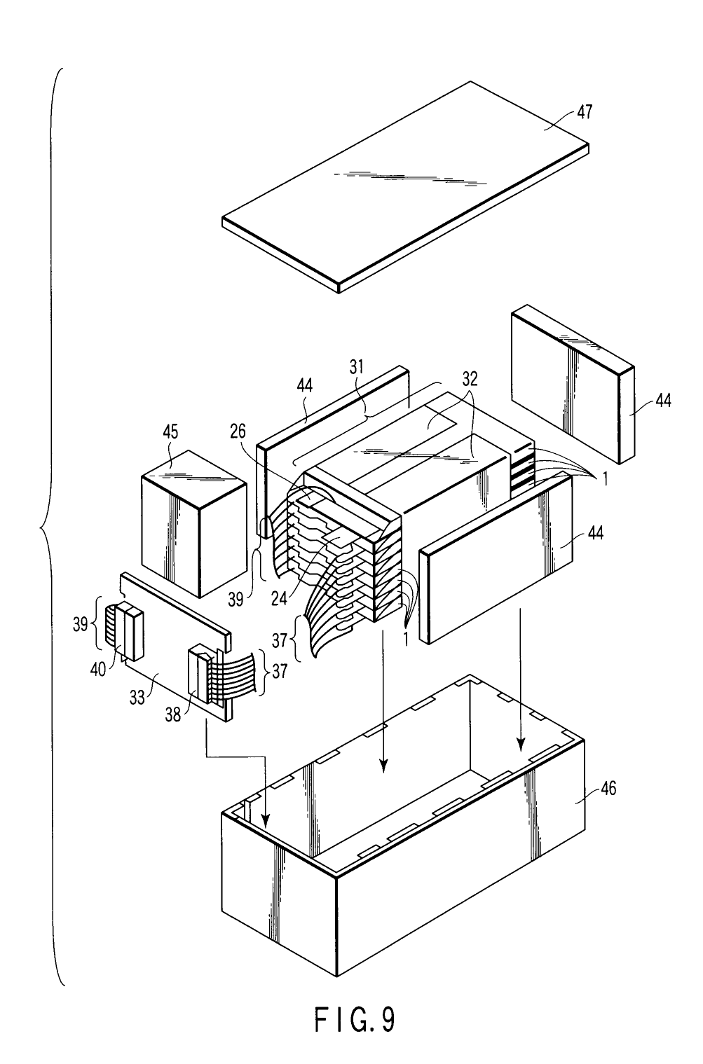

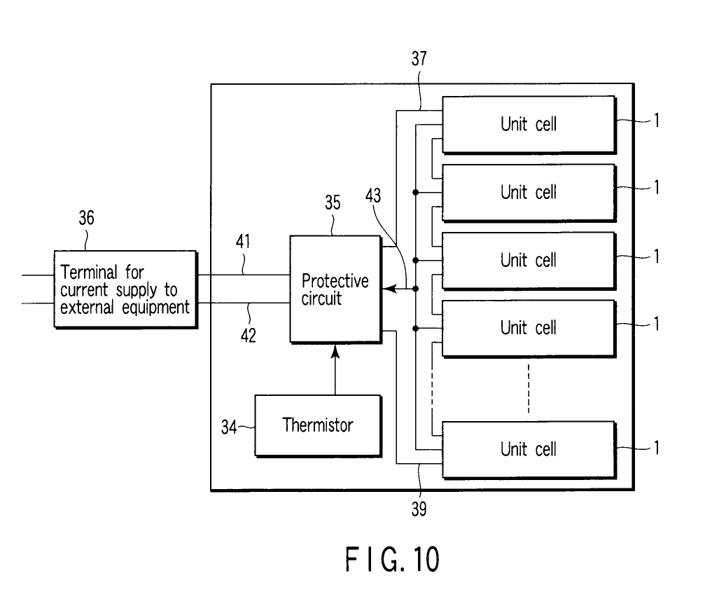

Each of a plurality of unit cells 1 included in the battery pack shown in FIG. 9 is formed of, though not limited to, a flattened type nonaqueous electrolyte battery constructed as shown in FIG. 1. The plural unit cells 1 are stacked one upon the other in the thickness direction in a manner to align the protruding directions of the positive electrode terminals 24 and the negative electrode terminals 26. As shown in FIG. 10, the unit cells 1 are connected in series to form a battery module 31. The unit cells 1 forming the battery module 31 are made integral by using an adhesive tape 32 as shown in FIG. 9.

A printed wiring board 33 is arranged on the side surface of the battery module 31 toward which protrude the positive electrode terminals 24 and the negative electrode terminals 26. As shown in FIG. 10, a thermistor 34, a protective circuit 35 and a terminal 36 for current supply to the external equipment are connected to the printed wiring board 33.

As shown in FIGS. 9 and 10, a wiring 37 on the side of the positive electrodes of the battery module 31 is electrically connected to a connector 38 on the side of the positive electrode of the protective circuit 35 mounted to the printed wiring board 33. On the other hand, a wiring 39 on the side of the negative electrodes of the battery module 31 is electrically connected to a connector 40 on the side of the negative electrode of the protective circuit 35 mounted to the printed wiring board 33.

The thermistor 34 detects the temperature of the unit cell 1 and transmits the detection signal to the protective circuit 35. The protective circuit 35 is capable of breaking a wiring 41 on the positive side and a wiring 42 on the negative side, the wirings 41 and 42 being stretched between the protective circuit 35 and the terminal 36 for current supply to the external equipment. These wirings 41 and 42 are broken by the protective circuit 35 under prescribed conditions including, for example, the conditions that the temperature detected by the thermistor is higher than a prescribed temperature, and that the over-charging, over-discharging and over-current of the unit cell 1 have been detected. The detecting method is applied to the unit cells 1 or to the battery module 31. In the case of applying the detecting method to each of the unit cells 1, it is possible to detect the battery voltage, the positive electrode potential or the negative electrode potential. On the other hand, where the positive electrode potential or the negative electrode potential is detected, lithium metal electrodes used as reference electrodes are inserted into the unit cells 1.

In the case of FIG. 10, a wiring 43 is connected to each of the unit cells 1 for detecting the voltage, and the detection signal is transmitted through these wirings 43 to the protective circuit 35.

Protective sheets 44 each formed of rubber or resin are arranged on the three of the four sides of the battery module 31, though the protective sheet 44 is not arranged on the side toward which protrude the positive electrode terminals 24 and the negative electrode terminals 26. A protective block 45 formed of rubber or resin is arranged in the clearance between the side surface of the battery module 31 and the printed wiring board 33.

The battery module 31 is housed in a container 46 together with each of the protective sheets 44, the protective block 45 and the printed wiring board 33. To be more specific, the protective sheets 44 are arranged inside the two long sides of the container 46 and inside one short side of the container 46. On the other hand, the printed wiring board 33 is arranged along that short side of the container 46 which is opposite to the short side along which one of the protective sheets 44 is arranged. The battery module 31 is positioned within the space surrounded by the three protective sheets 44 and the printed wiring board 33. Further, a lid 47 is mounted to close the upper open edge of the container 46.

Incidentally, it is possible to use a thermally shrinkable tube in place of the adhesive tape 32 for fixing the battery module 31. In this case, the protective sheets 44 are arranged on both sides of the battery module 31 and, after the thermally shrinkable tube is wound about the protective sheets, the tube is thermally shrunk to fix the battery module 31.

The unit cells 1 shown in FIGS. 9 and 10 are connected in series. However, it is also possible to connect the unit cells 1 in parallel to increase the cell capacity. Of course, it is possible to connect the battery packs in series and in parallel.

Also, the embodiments of the battery pack can be changed appropriately depending on the use of the battery pack.

The battery pack according to the second embodiment is preferably used when good cycle performance is required at a large current. Specifically, the battery pack is used for power sources of digital cameras, vehicle-mounted batteries for two-wheel or four-wheel hybrid electric cars, two-wheel or four-wheel electric cars and electric mopeds. Specifically, the aforementioned vehicle applications are exemplified.

### Third Embodiment

A vehicle according to a third embodiment comprises the battery pack according to the second embodiment, and is therefore superior in keeping the performance of the drive source. Examples of the vehicles here include two- to four-wheel hybrid electric cars, two- to four-wheel electric cars and power-assisted bicycles.

FIGS. 11 to 13 show various type of hybrid vehicles in which an internal combustion engine and a motor driven by a battery pack are used in combination as the power source for the driving. The hybrid vehicle can be roughly classified into three types depending on the combination of the internal combustion engine and the electric motor.

FIG. 11 shows a hybrid vehicle 50 that is generally called a series hybrid vehicle. The motive power of an internal combustion engine 51 is once converted entirely into an electric power by a power generator 52, and the electric power thus converted is stored in a battery pack 54 via an inverter 53. The battery pack according to the second embodiment is used as the battery pack 54. The electric power stored in the battery pack 54 is supplied to an electric motor 55 via the inverter 53, with the result that wheels 56 are driven by the electric motor 55. In other words, the hybrid vehicle 50 shown in FIG. 11 represents a system in which a power generator is incorporated into an electric vehicle. The internal combustion engine can be operated under highly efficient conditions and the kinetic energy of the internal combustion engine can be recovered as the electric power. On the other hand, the wheels are driven by the electric motor alone and, thus, the hybrid vehicle 50 requires an electric motor of a high output. It is also necessary to use a battery pack having a relatively large capacity. It is desirable for the rated capacity of the battery pack to fall within a range of 5 to 50 Ah, more desirably 10 to 20 Ah. Incidentally, the rated capacity noted above is the capacity at the time when the battery pack is discharged at a rate of 0.2 C.

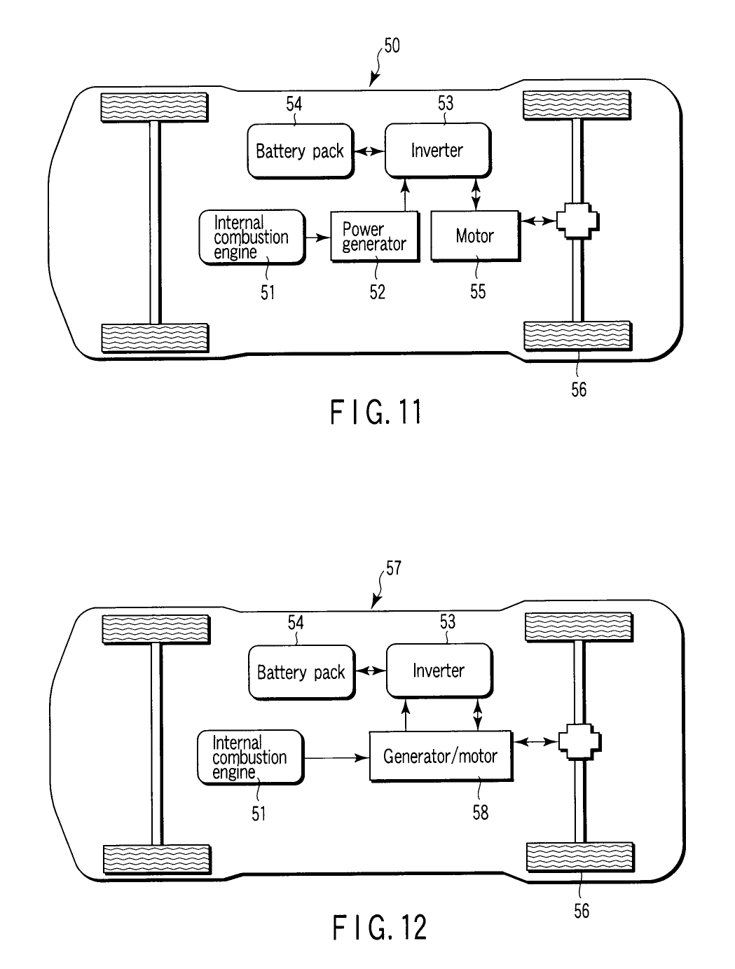

FIG. 12 shows the construction of a hybrid vehicle 57 that is called a parallel hybrid vehicle. A reference numeral 58 shown in FIG. 12 denotes an electric motor that also acts as a power generator. The internal combustion engine 51 drives mainly the wheels 56. The motive power of the internal combustion engine 51 is converted in some cases into an electric power by the power generator 58, and the battery pack 54 is charged by the electric power produced from the power generator 58. In the starting stage or the accelerating stage at which the load is increased, the driving force is supplemented by the electric motor 58. The hybrid vehicle 57 shown in FIG. 12 represents a system based on the ordinary vehicle. In this system, the fluctuation in the load of the internal combustion engine 51 is suppressed so as to improve the efficiency, and the regenerative power is also obtained. Since the wheels 56 are driven mainly by the internal combustion engine 51, the output of the electric motor 58 can be determined arbitrarily depending on the required ratio of the assistance. The system can be constructed even in the case of using a relatively small electric motor 58 and a relatively small battery pack 54. The rated capacity of the battery pack can be set to fall within a range of 1 to 20 Ah, more desirably 3 to 10 Ah.

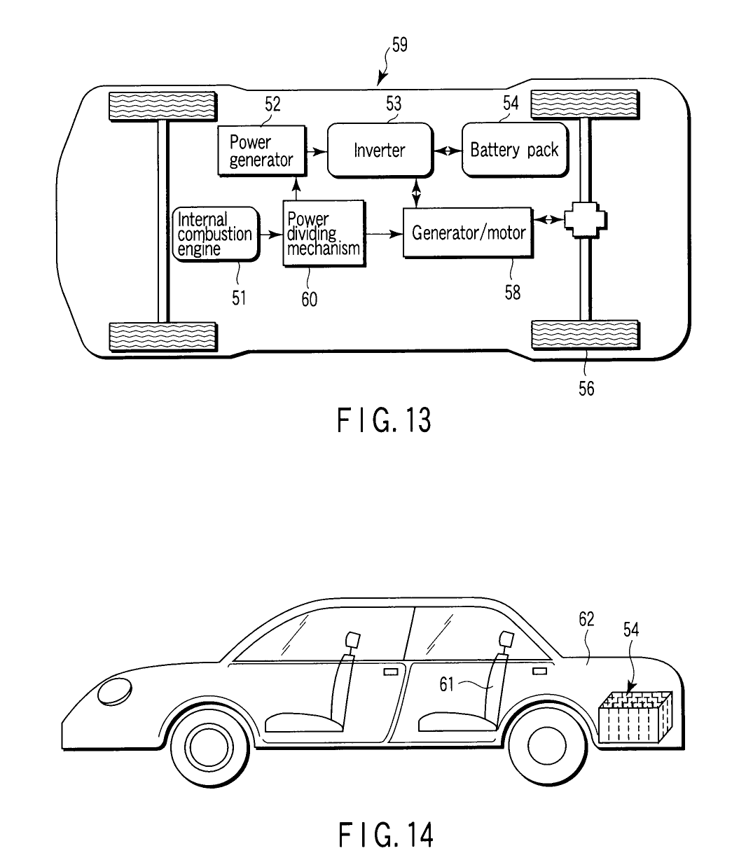

FIG. 13 shows the construction of a hybrid vehicle 59 that is called a series-parallel hybrid vehicle, which utilizes in combination both the series type system and the parallel type system. A power dividing mechanism 60 included in the hybrid vehicle 59 divides the output of the internal combustion engine 51 into the energy for the power generation and the energy for the wheel driving. The series-parallel hybrid vehicle 59 permits controlling the load of the engine more finely than the parallel hybrid vehicle so as to improve the energy efficiency.

It is desirable for the rated capacity of the battery pack to fall within a range of 1 to 20 Ah, more desirably 3 to 10 Ah.

It is desirable for the nominal voltage of the battery pack included in the hybrid vehicles as shown in FIGS. 11 to 13 to fall within a range of 200 to 600V.

It is desirable for the battery pack 54 to be arranged in general in the site where the battery pack 54 is unlikely to be affected by the change in the temperature of the outer atmosphere and unlikely to receive an impact in the event of a collision. In, for example, a sedan type automobile 62 shown in FIG. 14, the battery pack 54 can be arranged within a trunk room rearward of a rear seat 61. The battery pack 54 can also be arranged below or behind the rear seat 61. Where the battery has a large weight, it is desirable to arrange the battery pack 54 below the seat or below the floor in order to lower the center of gravity of the automobile.

An electric vehicle (EV) is driven by the energy stored in the battery pack that is charged by the electric power supplied from outside the vehicle. Since all the power required for the driving of the vehicle is produced by an electric motor, it is necessary to use an electric motor of a high output. In general, it is necessary to store all the energy required for one driving in the battery pack by one charging. It follows that it is necessary to use a battery pack having a very large capacity. It is desirable for the rated capacity of the battery pack to fall within a range of 100 to 500 Ah, more desirably 200 to 400 Ah.

The weight of the battery pack occupies a large ratio of the weight of the vehicle. Therefore, it is desirable for the battery pack to be arranged in a low position that is not markedly apart from the center of gravity of the vehicle. For example, it is desirable for the battery pack to be arranged below the floor of the vehicle. In order to allow the battery pack to be charged in a short time with a large amount of the electric power required for the one driving, it is necessary to use a charger of a large capacity and a charging cable. Therefore, it is desirable for the electric vehicle to be equipped with a charging connector connecting the charger and the charging cable. A connector utilizing the electric contact can be used as the charging connector. It is also possible to use a non-contact type charging connector utilizing the inductive coupling.

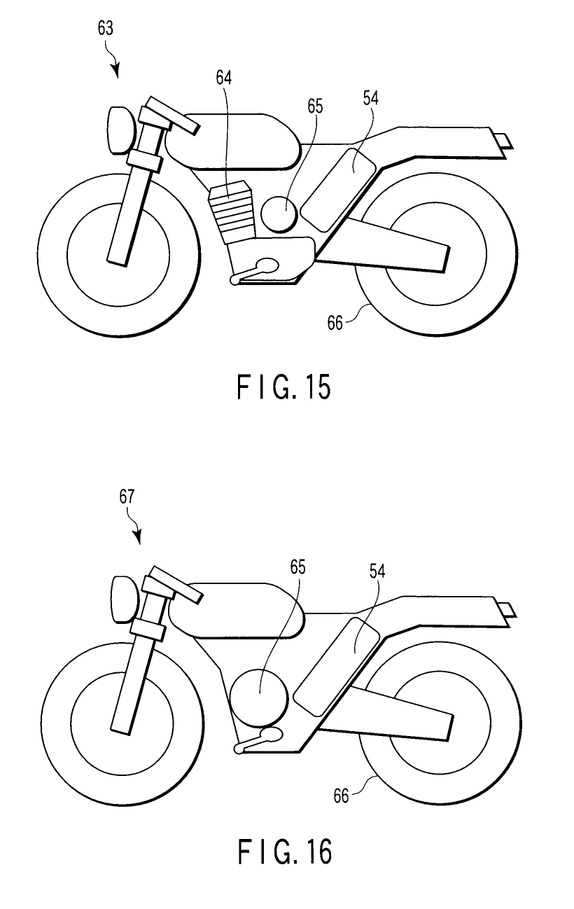

FIG. 15 exemplifies the construction of a hybrid motor bicycle 63. It is possible to construct a hybrid motor bicycle 63 exhibiting a high energy efficiency and equipped with an internal combustion engine 64, an electric motor 65, and the battery pack 54 like the hybrid vehicle. The internal combustion engine 64 drives mainly the wheels 66. In some cases, the battery pack 54 is charged by utilizing a part of the motive power generated from the internal combustion engine 64. In the starting stage or the accelerating stage in which the load of the motor bicycle is increased, the driving force of the motor bicycle is supplemented by the electric motor 65. Since the wheels 66 are driven mainly by the internal combustion engine 64, the output of the electric motor 65 can be determined arbitrarily based on the required ratio of the supplement. The electric motor 65 and the battery pack 54, which are relatively small, can be used for constructing the system. It is desirable for the rated capacity of the battery pack to fall within a range of 1 to 20 Ah, more desirably 3 to 10 Ah.

FIG. 16 exemplifies the construction of an electric motor bicycle 67. The electric motor bicycle 67 is driven by the energy stored in the battery pack 54 that is charged by the supply of the electric power from the outside. Since all the driving force required for the driving the motor bicycle 67 is generated from the electric motor 65, it is necessary to use the electric motor 65 of a high output. Also, since it is necessary for the battery pack to store all the energy required for one driving by one charging, it is necessary to use a battery pack having a relatively large capacity. It is desirable for the rated capacity of the battery pack to fall within a range of 10 to 50 Ah, more desirably 15 to 30 Ah.

### Fourth Embodiment

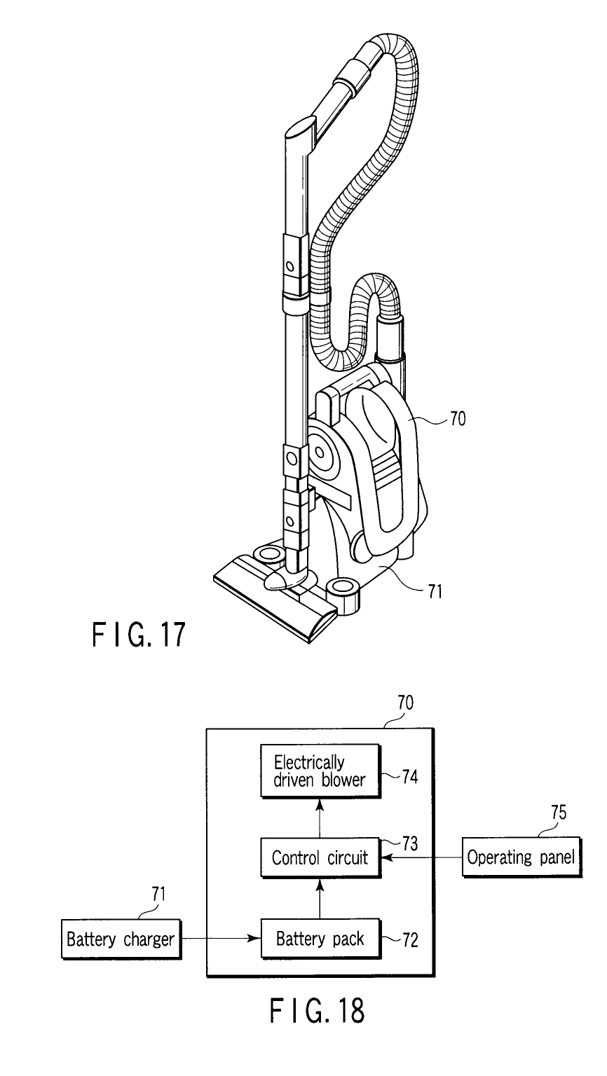

FIGS. 17 and 18 show an example of a rechargeable vacuum cleaner according to a fourth embodiment. The rechargeable vacuum cleaner comprises an operating panel 75 which selects operation modes, an electrically driven blower 74 comprising a fun motor for generating suction power for dust collection, and a control circuit 73. A battery pack 72 according to the second embodiment as a power source for driving these units are housed in a casing 70. When the battery pack is housed in such a portable device, the battery pack is desirably fixed with interposition of a buffer material in order to prevent the battery pack from being affected by vibration. Known technologies may be applied for maintaining the battery pack at an appropriate temperature. While a battery charger 71 that also serves as a setting table functions as the battery charger of the battery pack according to the second embodiment, a part or all of the function of the battery charger may be housed in the casing 70.

While the rechargeable vacuum cleaner consumes a large electric power, the rated capacity of the battery pack is desirably in the range of 2 to 10 Ah, more preferably 2 to 4 Ah, in terms of portability and operation time. The nominal voltage of the battery pack is desirably in the range of 40 to 80V.

The present invention will be explained in more detail by way of examples. However, the present invention is not limited to the examples described below and any modification or variation is possible as long as it is within the concepts of the present invention.

### EXAMPLE 1

A negative electrode was produced in the following manner.

Lithium titanate particles which had a specific surface area of 3 m²/g measured by a BET method using N₂ adsorption, and a spinel structure, and represented by the formula Li₄Ti₅O₁₂ (Li_{4/3}Ti_{5/3}O_{12/3}) were prepared as a negative electrode active material. To this negative electrode active material, coke particles having an average particle diameter of 1.12 μm and a specific surface area of 82 m²/g as a conductive agent, and polyvinylidene fluoride (PVdF) were mixed in a ratio by weight of 90:5:5 with N-methylpyrrolidone (NMP) to prepare a slurry. The obtained slurry was applied to a 15-μm-thick aluminum foil excluding its both end parts of the aluminum foil as viewed in the width direction and dried, followed by pressing to manufacture a band-shaped negative electrode having a thickness of 40 μm and a length of 40 cm. Incidentally, the both end parts were arranged on the long sides of the aluminum foil, respectively.

The widths of both end parts to which no slurry was applied were designed to be 17 mm and 2 mm, respectively. The maximum width G (width of the negative electrode layer to be applied) of the negative electrode layer was designed to be 5 cm. Also, the ratio of the thickness of both end parts as viewed in the width direction to the thickness of the part on which the negative electrode layer of the negative electrode current collector was formed was measured by observation using SEM, to find that the thickness ratio of the negative electrode current collector was 1.001. The negative electrode was bent such that the section obtained when it was cut along the short side direction had a curved shape.

One short side of the negative electrode was cut to form the top part having an isosceles triangle form as shown in the foregoing FIG. 2. The length F of the top part was designed to be 5.005 cm.

The average working potential of the negative electrode which was measured by the method explained below was 1.55V, which was higher than the lithium alloying potential of aluminum.

A positive electrode was manufactured in the following manner.

90% by weight of a lithium-cobalt oxide powder (LiCoO₂) as a positive electrode active material, 3% by weight of acetylene black, 3% by weight of graphite and 4% by weight of polyvinylidene fluoride (PVdF) were added to N-methylpyrrolidone (NMP) and these components were mixed to prepare a slurry. This slurry was applied to both surfaces of a current collector made of a 15-μm-thick aluminum foil excluding both end parts as viewed in the width direction, and dried, followed by pressing to produce a band-shaped positive electrode having a thickness of 34 μm and a length of 50 cm. The thickness of the positive electrode active material-containing layer of the obtained positive electrode was smaller than that of the negative electrode layer. Incidentally, the both end parts were arranged on the long sides of the aluminum foil, respectively.

The widths of both end parts to which no slurry was applied were designed to be 15 mm and 2 mm, respectively. The maximum width E (width of the positive electrode active material-containing layer to be applied) of the positive electrode active material-containing layer was designed to be 5 cm. Also, the ratio of the thickness of both end parts as viewed in the width direction to the thickness of the part on which the positive electrode active material-containing layer of the positive electrode current collector was formed was measured by observation using SEM, to find that the thickness ratio of the positive electrode current collector was 1.003. The positive electrode was bent such that the section obtained when it was cut along the short side direction had a curved shape.

One short side of the positive electrode was cut to form the top part having an isosceles triangle form as shown in the foregoing FIG. 2. The length D of the top part was designed to be 5.0125 cm.

The positive electrode, a separator made of a polyethylene porous film 25 μm in thickness, the negative electrode and a separator were laminated on each other in this order and then wound spirally in such a manner as to meet the following requirements (a) to (c).

(a) The plane projected as a result of the bending of each of the positive electrode and negative electrode was positioned on the outer periphery of the coiled product.

(b) The top part of the negative electrode was positioned between the top part of the positive electrode and the next positive electrode portion one round after the top part of positive electrode.

(c) The apex of the top part of the positive electrode was made to precede the apex of the top part of the negative electrode.

The obtained coiled product was pressed under heating at 90° C. to manufacture a flat electrode group having the structure shown in FIG. 3 and a width of 72 mm, a thickness T of 1.5 mm and a height H of 8 cm. The distance from the end of the electrode group at the height H to the apex of the top part of the positive electrode was 1 cm, which was longer than one-half (0.75 mm) of the thickness T of the electrode group. This implies that the top part of the positive electrode is disposed in the part B extending from the end of the electrode group at the height H to a position at a distance of one-half or more of the thickness T of the electrode group. Moreover, the distance C between the apex of the top part of the positive electrode and the apex of the top part of the negative electrode was 5 mm (0.5 cm). Therefore, the top part of the negative electrode preceded the part at which the positive electrode was first bent.

The obtained electrode group was received in a container made of a laminate film containing aluminum and the container was sealed except for its liquid injection port. Then, a solution obtained by dissolving 2M of LiBF₄ in γ-butyrolactone (GBL) was prepared as an electrolytic solution. The viscosity of the electrolytic solution at 20° C. was 10 cp. This electrolytic solution was injected into the container placed in an argon box. Then, an operation of deaerating until the vacuum reached 1 Torr for 5 minutes was repeated 10 times and then the liquid injection port was sealed and the obtained battery was subjected to a test.

The test was carried out using two kinds of methods.

Two types of batteries for experiments were prepared.

One type of battery was unsealed after the step of impregnating with the electrolytic solution to use it to confirm the degree of impregnation of the separator with the electrolytic solution. Because the separator was changed in brightness when it was impregnated with the electrolytic solution, the ratio of the area of the part reduced in brightness to the whole area was measured by image analysis as a degree of impregnation.

With regard to the other type of battery, 10 batteries were made and each battery was charged up to 2.8V under 0.2C for 12 hours as an initial charge, into a fully charged state. Then, each battery was subjected to 1 C discharge, 10 C discharge, 20 C discharge and 30 C discharge operations to find the current that can maintain a voltage of 2V for 10 seconds by extrapolating from the voltage obtained 10 seconds after the discharge was started. A value obtained by diving this current value by the weight of the battery is described in Table 2.

These results are shown in the following Table 2.

### EXAMPLES 2 TO 7 AND 11

Batteries were manufactured and also, the test was conducted in the same manner as in Example 1 except that the width of both ends of the long side of the negative electrode current collector, the ratio of the thickness of the negative electrode current collector, the maximum width G of the negative electrode layer in the short side direction, the length F of the top part of the negative electrode, the distance between the end of the electrode group at a height H and the apex of the top part of the positive electrode, and the distance C between the apex of the top part of the positive electrode and the apex of the top part of the negative electrode were altered to those shown in the following Tables 1 and 2.

### EXAMPLE 8

A battery was manufactured and the test was conducted in the same manner as in Example 1 except that, as the negative electrode active material, lithium titanate particles that had a specific surface area of 3 m²/g measured by a BET method using N₂ adsorption and a rhamsdelite structure and represented by Li₂Ti₃O₇ were used. In this case, the average working potential of the negative electrode was 1.6V which was higher than the lithium alloying potential of aluminum.

### EXAMPLE 9

A battery was manufactured and the test was made in the same manner as in Example 1 except that as the negative electrode active material, iron sulfide particles that had a specific surface area of 2 m²/g measured by a BET method using N₂ adsorption and represented by FeS were used. In this case, the average working potential of the negative electrode was 1.4V, which was higher than the lithium alloying potential of aluminum.

### EXAMPLE 10

A battery was manufactured and the test was conducted in the same manner as in Example 1 except that as the nonaqueous electrolyte, EMI.BF₄ containing LiBF₄ in a concentration of 1M as an ionic liquid was used. The viscosity of the nonaqueous electrolyte at 20° C. was 30 cp.

### COMPARATIVE EXAMPLE 1

A battery was manufactured and also, the test was conducted in the same manner as in Example 1 except that the apex of the top part of the negative electrode was made to precede the apex of the top part of the positive electrode, and the width of both ends of the long side of the negative electrode current collector, the ratio of the thickness of the negative electrode current collector, the maximum width G of the negative electrode layer in the short side direction and the length F of the top part of the negative electrode were set as shown in the following Tables 1 and 2. In this case, the distance between the end of the electrode group at a height H and the apex of the top part of the negative electrode was set to 3 cm and the distance between the apex of the top part of the positive electrode and the apex of the top part of the negative electrode was set to 10 mm.

### COMPARATIVE EXAMPLE 2

A battery was manufactured and also, the test was conducted in the same manner as in Comparative Example 1 except that a copper foil was used as the negative electrode current collector and the ratio of the thickness of the negative electrode current collector was altered to that shown in the following Table 2.

### COMPARATIVE EXAMPLE 3

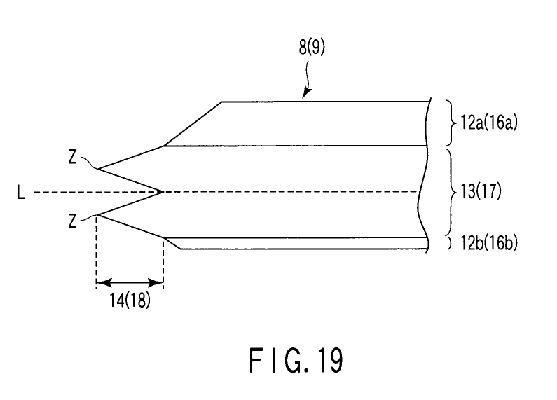

A battery having almost the same structure as in Example 1 was manufactured except that the shapes of the top part 14 of the positive electrode 8 and the top part 18 of the negative electrode 9 were changed to a form in which, as illustrated in FIG. 19, two isosceles triangles were disposed in a row in such a manner that they are divided by a boundary at the position (shown by the straight line L) corresponding to one-half of the maximum width of the active material-containing layers 13 and 17 of the positive and negative electrodes in the direction of the short sides. In this case, these electrodes were twisted when coiled, which caused the formation of a hole in the separator, so that a short circuit was developed during pressing after the coil was formed, making it impossible to manufacture a battery. This is thought to be because, though the top parts 14 and 18 of the positive and negative electrodes 8 and 9 used in Comparative Example 3 have a shape line-symmetric with respect to the line L, this shape is a top-split form in which two apexes Z are present at positions out of the line L and therefore, the top parts 14 and 18 have inferior strength.

TABLE 1

| | | | | Short side width of | Short side width of | |
|---|---|---|---|---|---|---|
| | | | | long side end | long side end | Ratio of |
| | Negative | Negative | | (terminal connection | (terminal connection | thickness |
| | electrode | electrode | | side) of negative | side) of negative | of negative |
| | active | current | Nonaqueous | electrode current | electrode current | electrode |
| | material | collector | electrolyte | collector (mm) | collector (mm) | current collector |
| Example 1 | Li_{4/3}Ti_{5/3}O_{12/3} | Al | 2M LiBF₄-GBL | 17 | 2 | 1.001 |
| Example 2 | Li_{4/3}Ti_{5/3}O_{12/3} | Al | 2M LiBF₄-GBL | 40 | 1 | 1.002 |
| Example 3 | Li_{4/3}Ti_{5/3}O_{12/3} | Al | 2M LiBF₄-GBL | 20 | 5 | 1.004 |
| Example 4 | Li_{4/3}Ti_{5/3}O_{12/3} | Al | 2M LiBF₄-GBL | 20 | 5 | 1.001 |
| Example 5 | Li_{4/3}Ti_{5/3}O_{12/3} | Al | 2M LiBF₄-GBL | 20 | 5 | 1.004 |
| Example 6 | Li_{4/3}Ti_{5/3}O_{12/3} | Al | 2M LiBF₄-GBL | 20 | 5 | 1.010 |
| Example 7 | Li_{4/3}Ti_{5/3}O_{12/3} | Al | 2M LiBF₄-GBL | 20 | 2 | 1.003 |
| Example 8 | Li₂Ti₃O₇ | Al | 2M LiBF₄-GBL | 17 | 2 | 1.001 |
| Example 9 | FeS | Al | 2M LiBF₄-GBL | 17 | 2 | 1.001 |
| Example 10 | Li_{4/3}Ti_{5/3}O_{12/3} | Al | 1MLiBF₄-EMI · BF₄ | 17 | 2 | 1.001 |
| Example 11 | Li_{4/3}Ti_{5/3}O_{12/3} | Al | 2M LiBF₄-GBL | 17 | 2 | 1.001 |
| Comparative | Li_{4/3}Ti_{5/3}O_{12/3} | Al | 2M LiBF₄-GBL | 20 | 5 | 1.001 |
| Example 1 | | | | | | |
| Comparative | Li_{4/3}Ti_{5/3}O_{12/3} | Cu | 2M LiBF₄-GBL | 20 | 5 | 1.000 |
| Example 2 | | | | | | |

TABLE 2

| | Maximum width | | | Distance | | | |
|---|---|---|---|---|---|---|---|
| | G of negative | Length | | between positive | Distance C | | Current value |
| | electrode | F of | Height | electrode top | between positive | | capable of |
| | active | negative | H of | part and | electrode top | | maintaining |
| | material- | electrode | electrode | electrode | part and negative | Degree | 2 V for 10 seconds, |
| | containing | top part | group | group end part | electrode top | of | per 1 g of the |
| | layer (cm) | (cm) | (cm) | (cm) | part (cm) | impregnation | battery [A/g] |
| Example 1 | 5 | 5.005 | 8 | 1 | 0.5 | 99 ± 1% | 1.2 |
| Example 2 | 5 | 5.010 | 8 | 0.5 | 1.0 | 99 ± 1% | 1.1 |
| Example 3 | 5 | 5.020 | 8 | 1.980 | 0.5 | 99 ± 1% | 1.1 |
| Example 4 | 5 | 5.005 | 8 | 2.295 | 0.05 | 95 ± 1% | 1.0 |
| Example 5 | 5 | 5.050 | 8 | 1 | 0.05 | 95 ± 1% | 1.0 |
| Example 6 | 5 | 5.010 | 8 | 1 | 0.05 | 93 ± 1% | 0.8 |
| Example 7 | 5 | 5.010 | 8 | 1 | 0.05 | 92 ± 1% | 0.8 |
| Example 8 | 5 | 5.005 | 8 | 1 | 0.05 | 99 ± 1% | 1.5 |
| Example 9 | 5 | 5.005 | 8 | 1 | 0.05 | 99 ± 1% | 1.5 |
| Example 10 | 5 | 5.005 | 8 | 1 | 0.05 | 99 ± 1% | 1.5 |
| Example 11 | 5 | 5.010 | 11 | 0.5 | 5.0 | 99 ± 1% | 1.5 |
| Comparative | 5 | 4 | 8 | — | — | 50% ± 5% | 0.4 |
| Example 1 | | | | | | | |
| Comparative | 5 | 4 | 8 | — | — | 50% ± 5% | 0.2 |
| Example 2 | | | | | | | |

As is clear from Tables 1 and 2, the batteries in Examples 1 to 11 each had characteristics superior in the electrolytic solution impregnation ability of the separator to each of Comparative Examples 1 and 2 and also in output performance. It is understood from the comparison among Examples 1 to 4 that high power is obtained in Examples 1 to 3 in which the distance between the end (end parallel to the coil axis) of the electrode group at a height H and the apex of the top part of the positive electrode is one-half or less of the height H of the electrode group. Also, it was confirmed from the results of Examples 8, 9 and 10 that the same effects as those obtained in Example 1 were obtained even if the type of negative electrode active material was changed or a nonaqueous electrolyte containing an ionic liquid was used.

On the other hand, Comparative Example 1 in which the top part of the negative electrode was made to precede the top part of the positive electrode and Comparative Example 2 in which a Cu foil was used as the negative electrode current collector were deteriorated not only in the electrolytic solution impregnation ability of the separator but also in output performance.

The average working potential of the negative electrode used in Examples was measured using the method explained below.

The negative electrode was cut into a size of 2 cm×2 cm to make a working electrode. This working electrode was made to face a counter electrode made of a 2.2 cm×2.2 cm lithium metal foil with a glass filter separator interposed therebetween. A lithium metal was inserted as a reference electrode so as not to be in contact with the working electrode and the counter electrode. These electrodes were received in a glass cell of a three pole type, and the working electrode, counter electrode and reference electrode were each connected to terminals of the glass cell. 1.5 M/L of LiBF₄ was dissolved in a solvent prepared by mixing ethylene carbonate with γ-butyrolactone in a ratio by volume of 1:2 to prepare an electrolytic solution. 25 mL of the obtained electrolytic solution was poured into a glass cell to impregnate the separator and electrode with the electrolytic solution sufficiently and then, the glass cell was sealed. After that, the glass cell was disposed in a 25° C. thermostat to charge up to 0.5V at a current density of 0.1 mA/cm² and then to discharge to 2V to measure the discharge electric power consumption, thereby calculating an average working potential by dividing the discharge electric power consumption by the discharge amount of electricity.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A nonaqueous electrolyte battery comprising an electrode group in which a band-shaped positive electrode and a band-shaped negative electrode are wound in the form of a flat coil with a separator interposed between the positive and negative electrodes, and a nonaqueous electrolyte supported by the electrode group,
the negative electrode including:
a negative electrode current collector made of aluminum or an aluminum alloy;
a negative electrode layer which is formed on the negative electrode current collector excluding at least both end parts as viewed in a width direction of the current collector and contains a negative electrode active material providing a negative electrode average working potential higher than a lithium alloying potential of aluminum; and
a top part gradually decreased in width towards an apex of the top part on one end of the current collector as viewed in a length direction of the current collector, and the apex of the top part arranged at a position corresponding to one-half of a maximum width of the negative electrode layer, and the top part having a shape symmetric with respect to the position;
the positive electrode including an end portion as viewed in a length direction of the positive electrode;
wherein the top part of the negative electrode is arranged between the end portion of the positive electrode and a positive electrode portion outward of the end portion of the positive electrode, and the end portion of the positive electrode is arranged at a position preceding the top part of the negative electrode.

2. The battery according to claim 1, wherein the positive electrode includes:
a positive electrode current collector;
a positive electrode active material-containing layer which is formed on the positive electrode current collector excluding at least both end parts as viewed in a width direction of the current collector; and
a top part gradually decreased in width towards an apex of the top part on the end portion of the positive electrode, and the apex of the top part being arranged at a position corresponding to one-half of a maximum width of the positive electrode active material-containing layer, and the top part having a shape symmetric with respect to the position.

3. The battery according to claim 2, wherein the top part of the positive electrode is arranged in a part extending from an end parallel to a coil axis of the electrode group, to a position at a distance of one-half or more of a thickness of the electrode group, and a distance between the apex of the top part of the positive electrode and the apex of the top part of the negative electrode is 0.5 to 50 mm.

4. The battery according to claim 1, wherein the negative electrode active material has a specific surface area of 1 to 10 m²/g.

5. The battery according to claim 1, wherein the nonaqueous electrolyte has a viscosity of 5 cp or more at 20° C.

6. The battery according to claim 1, wherein the top part of the negative electrode has an isosceles triangle form or a semicircle form.

7. The battery according to claim 1, wherein the negative electrode active material is lithium titanate.

8. The battery according to claim 1, wherein the positive electrode and the negative electrode are respectively curved such that each section obtained when they are cut along width directions of the positive and negative electrodes respectively has a curved form, and a plane projected due to a bending of the positive electrode and a plane projected due to a bending of the negative electrode are respectively positioned on an outer peripheral side of the electrode group.

9. A battery pack comprising a nonaqueous electrolyte battery comprising an electrode group in which a band-shaped positive electrode and a band-shaped negative electrode are wound in the form of a flat coil with a separator interposed between the positive and negative electrodes, and a nonaqueous electrolyte supported by the electrode group,
the negative electrode including:
a negative electrode current collector made of aluminum or an aluminum alloy;
a negative electrode layer which is formed on the negative electrode current collector excluding at least both end parts as viewed in a width direction of the current collector and contains a negative electrode active material providing a negative electrode average working potential higher than a lithium alloying potential of aluminum; and
a top part gradually decreased in width towards an apex of the top part on one end of the current collector as viewed in a length direction of the current collector, and the apex of the top part arranged at a position corresponding to one-half of a maximum width of the negative electrode layer, and the top part having a shape symmetric with respect to the position;
the positive electrode including an end portion as viewed in a length direction of the positive electrode;
wherein the top part of the negative electrode is arranged between the end portion of the positive electrode and a positive electrode portion outward of the end portion of the positive electrode, and the end portion of the positive electrode is arranged at a position preceding the top part of the negative electrode.

10. The battery pack according to claim 9, wherein the positive electrode includes:
a positive electrode current collector;
a positive electrode active material-containing layer which is formed on the positive electrode current collector excluding at least both end parts as viewed in a width direction of the current collector; and
a top part gradually decreased in width towards an apex of the top part on the end portion of the positive electrode, and the apex of the top part being arranged at a position corresponding to one-half of a maximum width of the positive electrode active material-containing layer, and the top part having a shape symmetric with respect to the position.

11. The battery pack according to claim 10, wherein the top part of the positive electrode is arranged in a part extending from an end parallel to a coil axis of the electrode group, to a position at a distance of one-half or more of a thickness of the electrode group, and a distance between the apex of the top part of the positive electrode and the apex of the top part of the negative electrode is 0.5 to 50 mm.

12. The battery pack according to claim 9, wherein the negative electrode active material has a specific surface area of 1 to 10 m²/g.

13. The battery pack according to claim 9, wherein the nonaqueous electrolyte has a viscosity of 5 cp or more at 20° C.

14. The battery pack according to claim 9, wherein the top part of the negative electrode has an isosceles triangle form or a semicircle form.

15. The battery pack according to claim 9, wherein the negative electrode active material is lithium titanate.

16. The battery pack according to claim 9, wherein the positive electrode and the negative electrode are respectively curved such that each section obtained when they are cut along width directions of the positive and negative electrodes respectively has a curved form, and a plane projected due to a bending of the positive electrode and a plane projected due to a bending of the negative electrode are respectively positioned on an outer peripheral side of the electrode group.

17. A vehicle comprising the nonaqueous electrolyte battery according to claim 1.
